(19) United States
(12) Patent Application Publication
(10) Pub. No.: US 2018/0062779 A1
(43) Pub. Date: Mar. 1, 2018

(54) PARALLEL TRANSMISSIONS

(71) Applicant: QUALCOMM Incorporated, San Diego, CA (US)

(72) Inventor: Tao Luo, San Diego, CA (US)

(21) Appl. No.: 15/644,651

(22) Filed: Jul. 7, 2017

Related U.S. Application Data
(60) Provisional application No. 62/381,548, filed on Aug. 30, 2016.

(51) Int. Cl. H04J 1/02; H04L 5/00; H04W 72/04; H04W 72/14

(52) U.S. Cl. CPC H04J 1/02; H04L 5/0007; H04L 5/0048; H04W 72/14; H04W 72/044

(57) ABSTRACT

Various aspects of the disclosure relate to communication involving parallel transmissions. In some aspects, a user equipment (UE) conducts two or more transmissions during the same time interval. To this end, the UE may determine how to multiplex the traffic for the transmissions. For example, the transmissions may originally be designated to use different transmission properties. In this case, the UE may align the transmissions by changing one or more transmission properties for one or more of the transmissions. In addition, the UE may send an indication of the selected traffic multiplexing to a transmit receiver point (TRP) or some other suitable apparatus.

### CROSS-REFERENCE TO RELATED APPLICATIONS

This application claims priority to and the benefit of U.S. Provisional Application Ser. No. 62/381,548, entitled “PARALLEL TRANSMISSIONS” filed on Aug. 30, 2016, the entire contents of which is incorporated herein by reference.

### INTRODUCTION

Various aspects described herein relate to wireless communication and, more particularly but not exclusively, to communication involving parallel transmissions.

Wireless communication networks are widely deployed to provide various communication services such as telephony, video, data, messaging, broadcasts, and so on. Such networks, which are usually multiple access networks, support communication for multiple users by sharing the available network resources.

In some scenarios, a transmitting device may need to conduct multiple transmissions during a common time interval. In addition, the characteristics of these transmissions may be different. Consequently, there is a need for effective techniques for supporting such overlapping transmissions.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In some aspects, the disclosure provides a method for communication including: determining that an apparatus is to conduct, during a common time interval, a first transmission using at least one first transmission property and a second transmission using at least one second transmission property; deciding whether to change the at least one first transmission property, the at least one second transmission property, or any combination thereof, wherein the decision is made as a result of the determination; and conducting the first transmission and the second transmission according to the decision.

Another aspect of the disclosure provides an apparatus configured for communication that includes a memory and a processor coupled to the memory. The processor and the memory are configured to: determine that an apparatus is to conduct, during a common time interval, a first transmission using at least one first transmission property and a second transmission using at least one second transmission property; decide whether to change the at least one first transmission property, the at least one second transmission property, or any combination thereof, wherein the decision is made as a result of the determination; and conduct the first transmission and the second transmission according to the decision.

Another aspect of the disclosure provides an apparatus configured for communication. The apparatus including: means for determining that an apparatus is to conduct, during a common time interval, a first transmission using at least one first transmission property and a second transmission using at least one second transmission property; means for deciding whether to change the at least one first transmission property, the at least one second transmission property, or any combination thereof, wherein the decision is made as a result of the determination; and means for conducting the first transmission and the second transmission according to the decision.

Another aspect of the disclosure provides a non-transitory computer-readable medium storing computer-executable code, including code to: determine that an apparatus is to conduct, during a common time interval, a first transmission using at least one first transmission property and a second transmission using at least one second transmission property; decide whether to change the at least one first transmission property, the at least one second transmission property, or any combination thereof, wherein the decision is made as a result of the determination; and conduct the first transmission and the second transmission according to the decision.

In some aspects, the disclosure provides a method for communication including: determining (e.g., obtaining) an indication of at least one transmission property used by an apparatus to conduct a first transmission and a second transmission during a common time interval; and receiving one or both of the first transmission or the second transmission according to the at least one transmission property.

Another aspect of the disclosure provides an apparatus configured for communication that includes a memory and a processor coupled to the memory. The processor and the memory are configured to: determine (e.g., obtain) an indication of at least one transmission property used by an apparatus to conduct a first transmission and a second transmission during a common time interval; and receive one or both of the first transmission or the second transmission according to the at least one transmission property.

Another aspect of the disclosure provides an apparatus configured for communication. The apparatus including: means for determining (e.g., obtaining) an indication of at least one transmission property used by an apparatus to conduct a first transmission and a second transmission during a common time interval; and means for receiving one or both of the first transmission or the second transmission according to the at least one transmission property.

Another aspect of the disclosure provides a non-transitory computer-readable medium storing computer-executable code, including code to: determine (e.g., obtain) an indication of at least one transmission property used by an apparatus to conduct a first transmission and a second transmission during a common time interval; and receive one or both of the first transmission or the second transmission according to the at least one transmission property.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

The accompanying drawings are presented to aid in the description of aspects of the disclosure and are provided solely for illustration of the aspects and not limitations thereof.

FIG. 1 is a block diagram of an example communication system within which aspects of the disclosure may be implemented.

FIG. 2 is a block diagram of an example communication system for communicating via parallel transmissions in accordance with some aspects of the disclosure.

FIG. 3 is a diagram illustrating examples of parallel transmissions in accordance with some aspects of the disclosure.

FIG. 4 is a block diagram of an example communication system for selecting traffic multiplexing in accordance with some aspects of the disclosure.

FIG. 5 is a block diagram of an example communication system for communicating an indication of selected traffic multiplexing in accordance with some aspects of the disclosure.

FIG. 6 is a block diagram illustrating an example hardware implementation for an apparatus (e.g., an electronic device) that can support communication in accordance with some aspects of the disclosure.

FIG. 7 is a flowchart illustrating an example communication process in accordance with some aspects of the disclosure.

FIG. 8 is a block diagram illustrating an example hardware implementation for another apparatus (e.g., an electronic device) that can support communication in accordance with some aspects of the disclosure.

FIG. 9 is a flowchart illustrating another example communication process in accordance with some aspects of the disclosure.

### DETAILED DESCRIPTION

Various aspects of the disclosure relate to communication involving parallel transmissions. In some aspects, a user equipment (UE) conducts two or more transmissions during the same time interval. To this end, the UE may determine how to multiplex the traffic for the transmissions. For example, the transmissions may originally be designated to use different transmission properties. In this case, the UE may align the transmissions by changing one or more transmission properties for one or more of the transmissions. In addition, the UE may send an indication of the selected traffic multiplexing to a transmit receiver point (TRP) or some other suitable apparatus.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. Moreover, alternate configurations may be devised without departing from the scope of the disclosure. Additionally, well-known elements will not be described in detail or will be omitted so as not to obscure the relevant details of the disclosure.

The various concepts presented throughout this disclosure may be implemented across a broad variety of telecommunication systems, network architectures, and communication standards. For example, the 3rd Generation Partnership Project (3GPP) is a standards body that defines several wireless communication standards for networks involving the evolved packet system (EPS), frequently referred to as long-term evolution (LTE) networks. Evolved versions of the LTE network, such as a fifth-generation (5G) network, may provide for many different types of services or applications, including but not limited to web browsing, video streaming, VoIP, mission critical applications, multi-hop networks, remote operations with real-time feedback (e.g., tele-surgery), etc. Thus, the teachings herein can be implemented according to various network technologies including, without limitation, 5G technology, fourth generation (4G) technology, third generation (3G) technology, and other network architectures. Also, the techniques described herein may be used for a downlink, an uplink, a peer-to-peer link, or some other type of link.

The teachings herein can thus be implemented according to various network technologies including, without limitation, fifth generation (5G) technology, fourth generation (4G) technology, third generation (3G) technology, and other network architectures. Thus, various aspects of the disclosure may be extended to networks based on 3rd Generation Partnership Project (3GPP) Long Term Evolution (LTE), LTE-Advanced (LTE-A) (in FDD, TDD, or both modes), Universal Mobile Telecommunications System (UMTS), Global System for Mobile Communications (GSM), Code Division Multiple Access (CDMA), Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard used will depend on the specific application and the overall design constraints imposed on the system. For purposes of illustration, the following may describe various aspects in the context of a 5G system or an LTE system. It should be appreciated, however, that the teachings herein may be used in other systems as well. Thus, references to functionality in the context of 5G or LTE terminology should be understood to be equally applicable to other types of technology, networks, components, signaling, and so on.

### Example Communication System

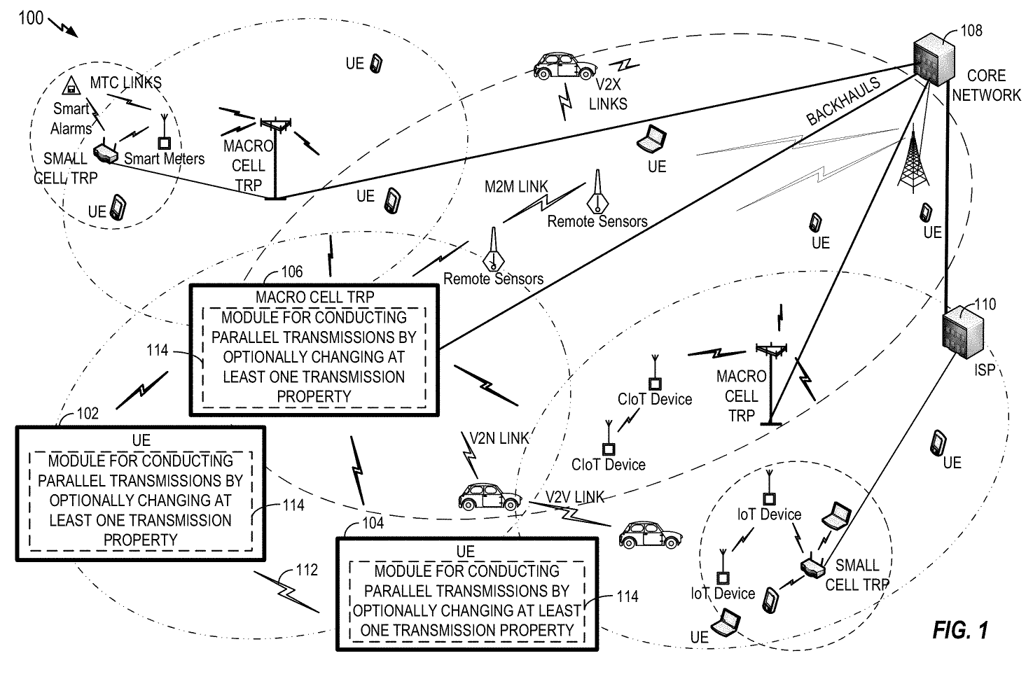

FIG. 1 illustrates an example of a wireless communication system 100 where a user equipment (UE) can communicate with other devices via wireless communication signaling. For example, a first UE 102 and a second UE 104 may communicate with a transmit receive point (TRP) 106 using wireless communication resources managed by the TRP 106 and/or other network components (e.g., a core network 108, an internet service provider (ISP) 110, peer devices, and so on). In some implementations, one or more of the components of the system 100 may communicate with each other directedly via a device-to-device (D2D) link 112 or some other similar type of direct link.

Communication of information between two or more of the components of the system 100 may involve parallel transmissions. For example, the UE 102 may conduct more than one transmission to the TRP 106. In accordance with the teachings herein, one or more of the UE 102, the UE 104, the TRP 106, or some other component of the system 100 may include a module for conducting parallel transmissions by optionally changing at least one transmission property 114.

The components and links of the wireless communication system 100 may take different forms in different implementations. Examples of UEs may include, without limitation, cellular devices, Internet of Things (IoT) devices, cellular IoT (CIoT) devices, LTE wireless cellular devices, machine-type communication (MTC) cellular devices, smart alarms, remote sensors, smart phones, mobile phones, smart meters, personal digital assistants (PDAs), personal computers, mesh nodes, and tablet computers.

In some aspects, a TRP may refer to a physical entity that incorporates radio head functionality for a particular physical cell. In some aspects, the TRP may include 5G new radio (NR) functionality with an air interface based on orthogonal frequency division multiplexing (OFDM). NR may support, for example and without limitation, enhanced mobile broadband (eMBB), mission-critical services, and wide-scale deployment of IoT devices. The functionality of a TRP may be similar in one or more aspects to (or include or be incorporated into) the functionality of a CIoT base station (C-BS), a NodeB, an evolved NodeB (eNodeB), radio access network (RAN) access node, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other suitable entity. In different scenarios (e.g., NR, LTE, etc.), a TRP may be referred to as a gNodeB (gNB), an eNB, a base station, or referenced using other terminology.

Various types of network-to-device links and D2D links may be supported in the wireless communication system 100. For example, D2D links may include, without limitation, machine-to-machine (M2M) links, MTC links, vehicle-to-vehicle (V2V) links, and vehicle-to-anything (V2X) links. Network-to-device links may include, without limitation, uplinks (or reverse links), downlinks (or forward links), and vehicle-to-network (V2N) links.

### Example Communication via Parallel Transmissions

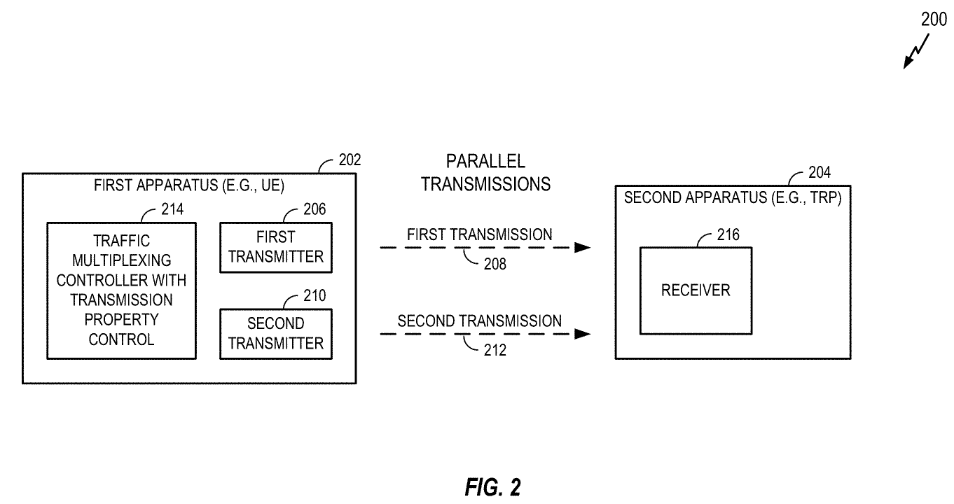

FIG. 2 illustrates a communication system 200 where, at some point in time, a first apparatus (hereafter, a UE 202) may communicate with a second apparatus (hereafter, a TRP 204) via parallel transmissions. In some implementations, the UE 202 may correspond to the UE 102 or the UE 104 of FIG. 1. In some implementations, the TRP 204 may correspond to the TRP 106 of FIG. 1. A first transmitter 206 of the UE 202 may transmit a first transmission 208 during the same time interval that a second transmitter 210 of the UE 202 may transmit a second transmission 212. For example, after scheduling one transmission (e.g., for standard data), a higher priority (e.g., mission-critical) transmission may need to be sent during the transmission period for the earlier scheduled transmission.

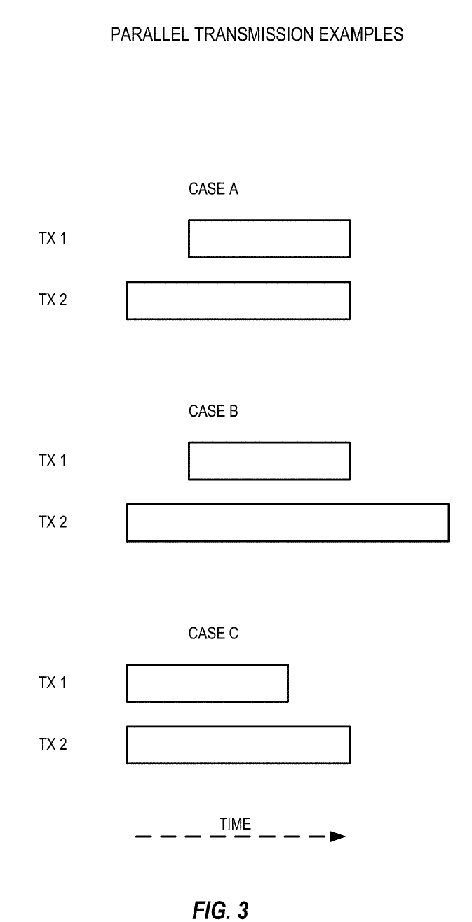

Thus, a transmitter may need to transmit more than one transmission (e.g., 2, 3, or more) in a common time interval. FIG. 3 illustrates simplified examples for two transmissions within a common time interval. In Case A, the first transmission (Tx1) starts later than the second transmission (Tx2) but finishes at the same time as Tx2. In Case B, Tx1 starts later than Tx2 but finishes earlier than Tx2. In Case C, Tx1 starts at the same time as Tx2 but finishes earlier than Tx2. The transmissions may be for the same component carrier in some scenarios or different component carriers in some scenarios. The time interval may be of various lengths (e.g., one sub-frame, multiple sub-frames, or some other period of time.)

Referring again to FIG. 2, in accordance with the teachings herein, a traffic multiplexing controller 214 with transmission property control may determine whether and/or how to best multiplex the first transmission 208 and the second transmission 212 (e.g., to mitigate interference between non-aligned or poorly aligned transmissions). As discussed in more detail below, in some cases, the traffic multiplexing controller 214 may elect to transmit the first transmission 208 and the second transmission 212 according to their original respective transmission properties. In other cases, however, the traffic multiplexing controller 214 may elect to change one or more of the transmission properties for one or both of the first transmission 208 and the second transmission 212. For example, the traffic multiplexing controller 214 (or some other suitable component) may choose the waveform (e.g., single-carrier frequency division multiple access or orthogonal frequency-division multiplexing) to be used during the common part of the transmissions. In addition, the traffic multiplexing controller 214 (or some other suitable component) may signal this choice to the TRP 204. In this way, a receiver 216 of the TRP 204 may more efficiently receive the first transmission 208 and the second transmission 212 from the UE 202.

### Example Transmission Properties Selection

The different transmissions may be initially assigned different transmission properties. For example, the first transmission (Tx1) and the second transmission (Tx2) may use different numerologies (e.g., different tone spacings or different cyclic prefix lengths). As another example, Tx1 and Tx2 may use a different number of layers (e.g., MIMO layers) for transmission. For example, a Tx2 enhanced mobile broadband (eMBB) transmission may use two layers, while a Tx1 transmission uses a single layer.

Also, the trigger for transmission of Tx1 and Tx2 may be different. For example, Tx2 may be indicated by a control channel by another transmitter (e.g., a TRP), while Tx1 may be a pre-configured or contention-based transmission. As a further example, Tx2 may be scheduled by a grant from a TRP on a physical downlink control channel (PDCCH), but Tx1 is not triggered by a grant.

In some implementations, Tx2 may use a single-carrier frequency division multiple access (SC-FDMA) waveform or an orthogonal frequency-division multiplexing (OFDM) waveform. SC-FDMA may take various forms. In some implementations, SC-FDMA may be implemented as discrete Fourier transform (DFT)-Spread-OFDM.

Tx1 and Tx2 may carry different types of traffic (e.g., with different requirements). For example, Tx2 may be used for regular traffic transmission such as enhanced mobile broadband (eMBB) in 5G. As another example, Tx1 may be used for traffic having different latency requirements and/or reliability requirements. For example, Tx1 may be for ultra-reliable low latency communication (URLLC).

The disclosure relates in some aspects to selectively aligning the properties of the transmissions if such an alignment may result in better performance The transmission properties may include, for example, and without limitation, tone (e.g., sub-carrier) spacing, cyclic prefix length (duration), and waveform type (e.g., SC-FDMA, OFDM, or other waveforms). In some aspects, a decision to as to whether to multiplex the traffic may be based on whether a change in one or more parameters will result in improved performance (e.g., the increase in performance exceeds a threshold).

In some implementations, Tx1 may be for autonomous transmission with pre-configured properties. For example, properties such as tone spacing and/or CP duration may be pre-configured for Tx1. Also, Tx1 may be a semi-persistent transmission, a contention-based transmission, or a grant-free transmission.

In some implementations, Tx2 may use a different tone spacing and/or CP duration than Tx1. In accordance with the teachings herein, the transmission properties (e.g., tone spacing and/or CP duration) for Tx1 may be changed so that they align with Tx2. Alignment may be for the overlapping part or all transmission parts of Tx2.

As a specific example, during an on-going SC-FDMA transmission for Tx2, there may be a need for an additional parallel transmission Tx1 for other traffic such as URLLC. These transmissions may partially overlap in time but be frequency division multiplexed (FDM) over frequency. Two options are described below.

In the first option, the individual transmission properties for Tx1 and Tx2 may be retained. In this case, the SC-FDMA waveform used for Tx2 and the waveform used for Tx1 are transmitted in parallel.

In the second option, SC-FDMA is used on at least the overlapping part between Tx1 and Tx2. That is, Tx1 and Tx2 are transmitted together using SC-FDMA. For example, a DFT spread could be done on the common overlapping part.

As another specific example, during an on-going OFDM transmission for Tx2, there may be a need for an additional parallel transmission Tx1 for other traffic such as URLLC. These transmissions may partially overlap in time but be frequency division multiplexed (FDM) over frequency. In this case, SC-FDMA may be used for the overlapping part. That is, Tx1 and Tx2 are transmitted together using SC-FDMA.

A decision by a UE (or other suitable apparatus) as to which way to multiplex the traffic for at the least overlapping part may be based on various factors.

In some cases, the decision may be based on a grant from a TRP for transmissions that are scheduled (e.g., via a control channel). For example, if there is an uplink grant for Tx1, this grant may overwrite some of the grant transmitted earlier for Tx2. Conversely, if there is an uplink grant for Tx2, this grant may overwrite any subsequent grant for Tx1.

In some cases, the decision may be based on available information when Tx1 is not scheduled by a control channel In some cases, the decision may be based on the modulation and coding scheme (MCS) for each transmission (e.g., the MCS for one transmission may be changed to match or better fit with the MCS for the other transmission). In some cases, the decision may be based on the rank for each transmission (e.g., the rank for one transmission may be changed to match or better fit with the tank for the other transmission). In some cases, the decision may be based on the resource block (RB) allocation for each transmission (e.g., the original transmission properties may be used if the resources are relatively far apart (e.g., in frequency), while the transmission properties may be changed if the resources are relatively close together). In some cases, the decision may be based on the resources available for the parallel transmissions (e.g., the original transmission properties may be used if the resources are relatively far apart, while the transmission properties may be changed if the resources are relatively close together). In some cases, the decision may be based on the resource location for Tx2 [and/or relative to the resource (Tx1)] used for the on-going transmission (e.g., the original transmission properties may be used if the resources are relatively far apart, while the transmission properties may be changed if the resources are relatively close together).

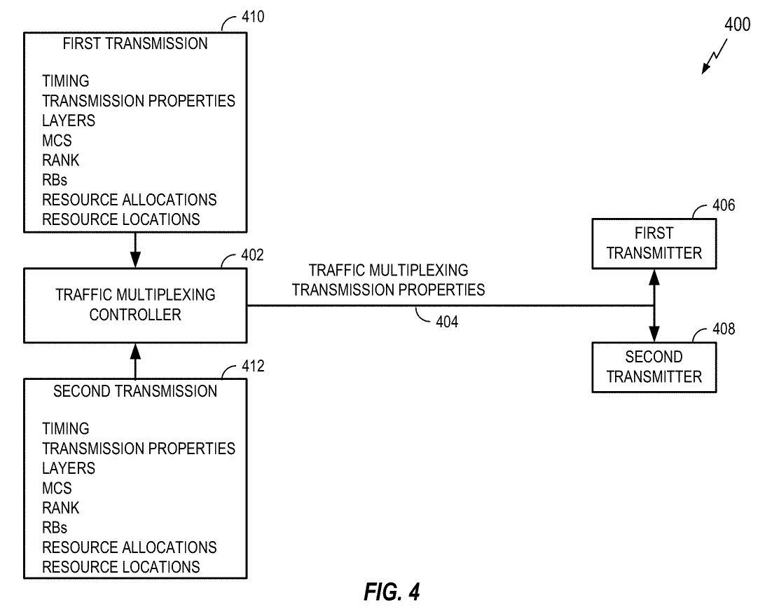

FIG. 4 illustrates an example of a communication system 400 where a traffic multiplexing controller 402 determines (e.g., selects) the transmission properties to be used by a first transmitter 406 and a second transmitter 408 based on one or more factors associated with the first transmission 410 and one or more factors associated with the second transmission 412. For example, if the timing of the first transmission and the timing of the second transmission indicate an overlap, the traffic multiplexing controller 402 may determine whether the originally assigned transmission properties should be aligned or if some other factor (e.g., MCS, Rank, etc.) should be aligned.

### Example Indication Signaling

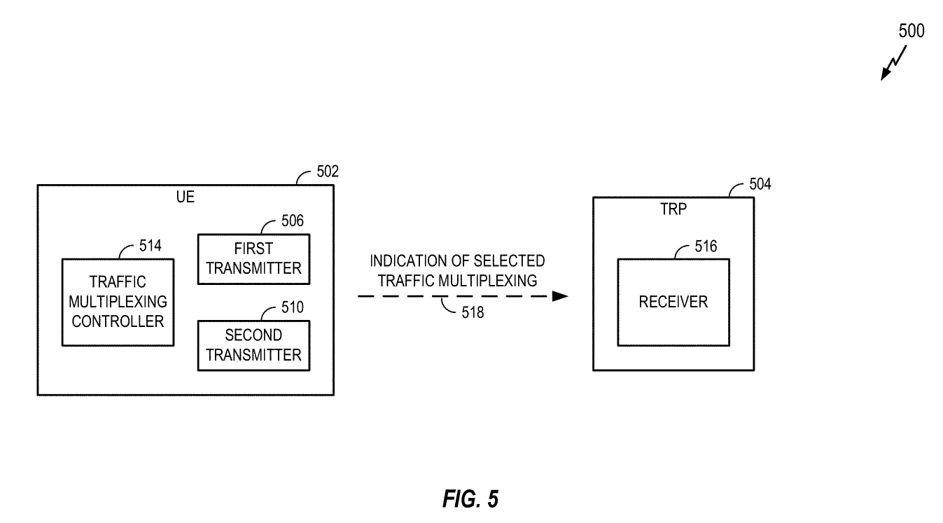

FIG. 5 illustrates a communication system 500 where a user equipment (UE) 502 may communicate with a transmit receive point (TRP) 504 via parallel transmissions. As in FIG. 2, a first transmitter 506 of the UE 502 may transmit a first transmission during the same time interval that a second transmitter 510 of the UE 502 may transmit a second transmission. These transmissions (not shown in FIG. 5) are received by a receiver 516 of the TRP 504.

In accordance with the teachings herein, a traffic multiplexing controller 514 (or some other suitable component) may send an indication 518 of the selected traffic multiplexing to the TRP 504. For example, the indication may indicate the numerology (e.g., tone spacing or cyclic prefix length) used for the transmissions, the waveform (e.g., SC-FDMA or OFDM) used for the transmissions, and so on. This can help the TRP to decode regular traffic and additional parallel transmission.

The indication may take various forms. In some aspects, a transmission may include signaling to indicate how a UE multiplexes parallel transmissions. In some aspects, a transmission may include signaling to indicate that the UE did not multiplex the transmissions (e.g., the UE transmitted the first and second transmissions as originally configured). In some aspects, the indication may indicate the duration of multiplexing (e.g., just the overlapping part, or the entirety of the transmission, or some other portion of the transmission).

The indication may be transmitted in various ways. This signaling can be achieved by using different demodulated reference signal (DMRS) patterns to indicate the form of multiplexing, if any, or by inserting a layer 1 signal (e.g., message) into a transmission. As an example of the former scenario, the UE may transmit a normal DMRS (e.g., within one or both transmissions) if the UE did not multiplex the transmissions (e.g., the UE transmitted the original waveforms). Conversely, the UE may transmit a different DMRS (e.g., within a transmission) if the UE did multiplex the transmission (e.g., SC-FDMA is used).

### First Example Apparatus

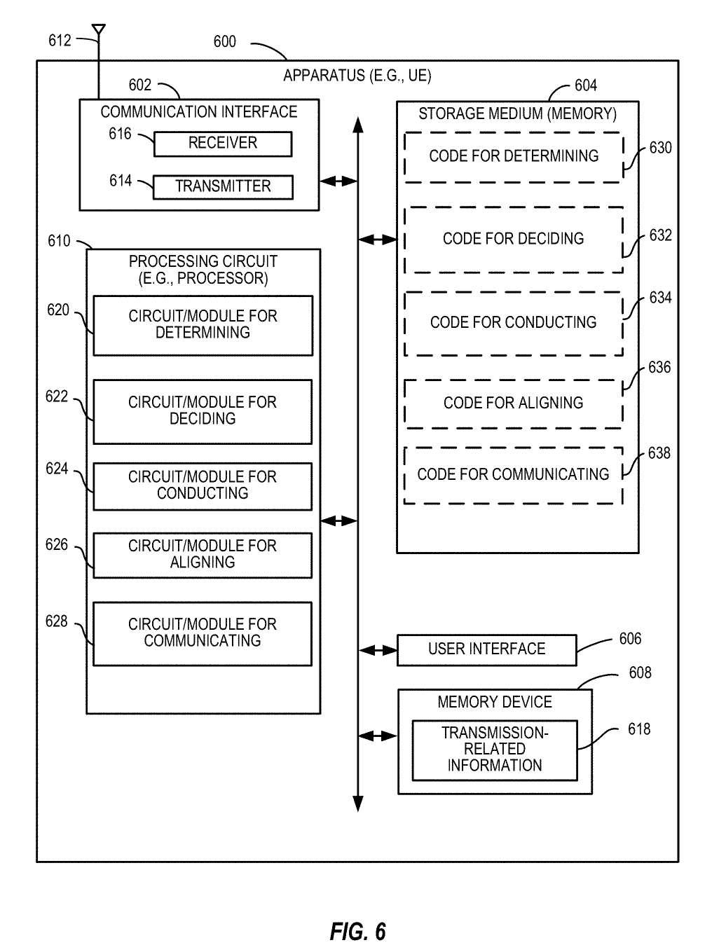

FIG. 6 illustrates a block diagram of an example hardware implementation of an apparatus 600 configured to communicate according to one or more aspects of the disclosure. The apparatus 600 could embody or be implemented within a UE, a TRP, a gNB, a base station (BS), or some other type of device that supports parallel transmissions as taught herein. In various implementations, the apparatus 600 could embody or be implemented within an access terminal, an access point, or some other type of device. In various implementations, the apparatus 600 could embody or be implemented within a server, a network entity, a mobile phone, a smart phone, a tablet, a portable computer, a server, a personal computer, a sensor, an entertainment device, a medical device, or any other electronic device having circuitry.

The apparatus 600 includes a communication interface (e.g., at least one transceiver) 602, a storage medium 604, a user interface 606, a memory device (e.g., a memory circuit) 608, and a processing circuit 610 (e.g., at least one processor). In various implementations, the user interface 606 may include one or more of: a keypad, a display, a speaker, a microphone, a touchscreen display, of some other circuitry for receiving an input from or sending an output to a user.

These components can be coupled to and/or placed in electrical communication with one another via a signaling bus or other suitable component, represented generally by the connection lines in FIG. 6. The signaling bus may include any number of interconnecting buses and bridges depending on the specific application of the processing circuit 610 and the overall design constraints. The signaling bus links together various circuits such that each of the communication interface 602, the storage medium 604, the user interface 606, and the memory device 608 are coupled to and/or in electrical communication with the processing circuit 610. The signaling bus may also link various other circuits (not shown) such as timing sources, peripherals, voltage regulators, and power management circuits, which are well known in the art, and therefore, will not be described any further.

The communication interface 602 provides a means for communicating with other apparatuses over a transmission medium. In some implementations, the communication interface 602 includes circuitry and/or programming adapted to facilitate the communication of information bi-directionally with respect to one or more communication devices in a network. In some implementations, the communication interface 602 is adapted to facilitate wireless communication of the apparatus 600. In these implementations, the communication interface 602 may be coupled to one or more antennas 612 as shown in FIG. 6 for wireless communication within a wireless communication system. The communication interface 602 can be configured with one or more standalone receivers and/or transmitters, as well as one or more transceivers. In the illustrated example, the communication interface 602 includes a transmitter 614 and a receiver 616. The communication interface 602 serves as one example of a means for receiving and/or means transmitting.

The memory device 608 may represent one or more memory devices. As indicated, the memory device 608 may maintain transmission-related information 618 along with other information used by the apparatus 600. In some implementations, the memory device 608 and the storage medium 604 are implemented as a common memory component. The memory device 608 may also be used for storing data that is manipulated by the processing circuit 610 or some other component of the apparatus 600.

The storage medium 604 may represent one or more computer-readable, machine-readable, and/or processor-readable devices for storing programming, such as processor executable code or instructions (e.g., software, firmware), electronic data, databases, or other digital information. The storage medium 604 may also be used for storing data that is manipulated by the processing circuit 610 when executing programming. The storage medium 604 may be any available media that can be accessed by a general purpose or special purpose processor, including portable or fixed storage devices, optical storage devices, and various other mediums capable of storing, containing or carrying programming.

By way of example and not limitation, the storage medium 604 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 604 may be embodied in an article of manufacture (e.g., a computer program product). By way of example, a computer program product may include a computer-readable medium in packaging materials. In view of the above, in some implementations, the storage medium 604 may be a non-transitory (e.g., tangible) storage medium.

The storage medium 604 may be coupled to the processing circuit 610 such that the processing circuit 610 can read information from, and write information to, the storage medium 604. That is, the storage medium 604 can be coupled to the processing circuit 610 so that the storage medium 604 is at least accessible by the processing circuit 610, including examples where at least one storage medium is integral to the processing circuit 610 and/or examples where at least one storage medium is separate from the processing circuit 610 (e.g., resident in the apparatus 600, external to the apparatus 600, distributed across multiple entities, etc.).

Programming stored by the storage medium 604, when executed by the processing circuit 610, causes the processing circuit 610 to perform one or more of the various functions and/or process operations described herein. For example, the storage medium 604 may include operations configured for regulating operations at one or more hardware blocks of the processing circuit 610, as well as to utilize the communication interface 602 for wireless communication utilizing their respective communication protocols.

The processing circuit 610 is generally adapted for processing, including the execution of such programming stored on the storage medium 604. As used herein, the terms “code” or “programming” shall be construed broadly to include without limitation instructions, instruction sets, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 610 is arranged to obtain, process and/or send data, control data access and storage, issue commands, and control other desired operations. The processing circuit 610 may include circuitry configured to implement desired programming provided by appropriate media in at least one example. For example, the processing circuit 610 may be implemented as one or more processors, one or more controllers, and/or other structure configured to execute executable programming. Examples of the processing circuit 610 may include a general purpose processor, a digital signal processor (DSP), an application-specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 610 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 610 are for illustration and other suitable configurations within the scope of the disclosure are also contemplated.

According to one or more aspects of the disclosure, the processing circuit 610 may be adapted to perform any or all of the features, processes, functions, operations and/or routines for any or all of the apparatuses described herein. For example, the processing circuit 610 may be configured to perform any of the steps, functions, and/or processes described with respect to FIGS. 1-5 and 7. As used herein, the term “adapted” in relation to the processing circuit 610 may refer to the processing circuit 610 being one or more of configured, used, implemented, and/or programmed to perform a particular process, function, operation and/or routine according to various features described herein.

The processing circuit 610 may be a specialized processor, such as an application-specific integrated circuit (ASIC) that serves as a means for (e.g., structure for) carrying out any one of the operations described in conjunction with FIGS. 1-5 and 7. The processing circuit 610 serves as one example of a means for transmitting and/or a means for receiving. In various implementations, the processing circuit 610 may provide and/or incorporate the functionality of the UE 202 of FIG. 2.

According to at least one example of the apparatus 600, the processing circuit 610 may include one or more of a circuit/module for determining 620, a circuit/module for deciding 622, a circuit/module for conducting 624, a circuit/module for aligning 626, or a circuit/module for communicating 628. In various implementations, the circuit/module for determining 620, the circuit/module for deciding 622, the circuit/module for conducting 624, the circuit/module for aligning 626, or the circuit/module for communicating 628 may provide and/or incorporate, at least in part, the functionality described above for the UE 202 of FIG. 2.

As mentioned above, programming stored by the storage medium 604, when executed by the processing circuit 610, causes the processing circuit 610 to perform one or more of the various functions and/or process operations described herein. For example, the programming, when executed by the processing circuit 610, may cause the processing circuit 610 to perform the various functions, steps, and/or processes described herein with respect to FIGS. 1-5 and 7 in various implementations. As shown in FIG. 6, the storage medium 604 may include one or more of code for determining 630, code for deciding 632, code for conducting 634, code for aligning 636, or code for communicating 638. In various implementations, the code for determining 630, the code for deciding 632, the code for conducting 634, the code for aligning 636, or the code for communicating 638 may be executed or otherwise used to provide the functionality described herein for the circuit/module for determining 620, the circuit/module for deciding 622, the circuit/module for conducting 624, the circuit/module for aligning 626, or the circuit/module for communicating 628.

The circuit/module for determining 620 may include circuitry and/or programming (e.g., code for determining 630 stored on the storage medium 604) adapted to perform several functions relating to, for example, determining that an apparatus is to conduct a transmission. In some aspects, the circuit/module for determining 620 (e.g., a means for determining) may correspond to, for example, a processing circuit.

In some scenarios, the circuit/module for determining 620 may obtain schedule information (e.g., from the communication interface 602, the memory device 608, or some other component of the apparatus 600). The circuit/module for determining 620 may then determine (e.g., based on the schedule information) that an apparatus is to conduct, during a common time interval, a first transmission using at least one first transmission property and a second transmission using at least one second transmission property. The circuit/module for determining 620 may then output an indication of the determination (e.g., to the circuit/module for deciding 622, the memory device 608, or some other component).

The circuit/module for deciding 622 may include circuitry and/or programming (e.g., code for deciding 632 stored on the storage medium 604) adapted to perform several functions relating to, for example, determining whether to change at least one transmission property. In some aspects, the circuit/module for deciding 622 (e.g., a means for deciding) may correspond to, for example, a processing circuit.

In some aspects, the circuit/module for deciding 622 may perform the decision operations described herein conjunction with FIGS. 1-5. For example, one or more transmission properties may be changed if the apparatus is to conduct a first transmission and a second transmission during a common time interval. The circuit/module for deciding 622 may then output the resulting decision (e.g., to the circuit/module for conducting 624, the memory device 608, the communication interface 602, or some other component).

The circuit/module for conducting 624 may include circuitry and/or programming (e.g., code for conducting 634 stored on the storage medium 604) adapted to perform several functions relating to, for example, conducting a transmission. The circuit/module for conducting 624 obtains information (e.g., from the memory device 608 or some other component of the apparatus 600), processes (e.g., encodes for transmission) the information, and outputs the processed information. In some scenarios, the transmission involves sending the information to another component of the apparatus 600 (e.g., the transmitter 614, the communication interface 602, or some other component) that will transmit the information to another device. In some scenarios (e.g., if the circuit/module for conducting 624 includes a transmitter), the transmitting involves the circuit/module for conducting 624 transmitting the information directly to another device (e.g., the ultimate destination) via radio frequency signaling or some other type of signaling suitable for the applicable communication medium.

The circuit/module for conducting 624 (e.g., a means for conducting) may take various forms. In some aspects, the circuit/module for conducting 624 may correspond to, for example, an interface (e.g., a bus interface, a send interface, or some other type of signal interface), a communication device, a transceiver, a transmitter, or some other similar component as discussed herein. In some implementations, the communication interface 602 includes the circuit/module for conducting 624 and/or the code for conducting 634. In some implementations, the circuit/module for conducting 624 and/or the code for conducting 634 is configured to control the communication interface 602 (e.g., a transceiver, a receiver, or a transmitter) to communicate the information.

The circuit/module for aligning 626 may include circuitry and/or programming (e.g., code for aligning 636 stored on the storage medium 604) adapted to perform several functions relating to, for example, aligning transmission properties. In some aspects, the circuit/module for aligning 626 (e.g., a means for aligning) may correspond to, for example, a processing circuit.

In some aspects, the circuit/module for aligning 626 may perform the alignment operations described herein conjunction with FIGS. 1-5. For example, two transmission properties may be aligned (e.g., in time) if the apparatus is to conduct a first transmission and a second transmission during a common time interval. The circuit/module for aligning 626 may then control a component of the apparatus 600 (e.g., to the circuit/module for conducting 624, the memory device 608, the communication interface 602, or some other component) to provide the desired alignment.

The circuit/module for communicating 628 may include circuitry and/or programming (e.g., code for communicating 638 stored on the storage medium 604) adapted to perform several functions relating to, for example, communicating information. In some implementations, the communication involves receiving the information. In some implementations, the communication involves sending (e.g., transmitting) the information.

In some implementations where the communicating involves receiving information, the circuit/module for communicating 628 receives information (e.g., from the communication interface 602, the receiver 616, the memory device 608, some other component of the apparatus 600, or some other device), processes (e.g., decodes) the information, and outputs the information to another component of the apparatus 600 (e.g., the memory device 608 or some other component). In some scenarios (e.g., if the circuit/module for communicating 628 includes a receiver), the communicating involves the circuit/module for communicating 628 receiving information directly from a device that transmitted the information (e.g., via radio frequency signaling or some other type of signaling suitable for the applicable communication medium).

In some implementations where the communicating involves sending information, the circuit/module for communicating 628 obtains information (e.g., from the memory device 608 or some other component of the apparatus 600), processes (e.g., encodes for transmission) the information, and outputs the processed information. In some scenarios, the communication involves sending the information to another component of the apparatus 600 (e.g., the transmitter 614, the communication interface 602, or some other component) that will transmit the information to another device. In some scenarios (e.g., if the circuit/module for communicating 628 includes a transmitter), the communication involves the circuit/module for communicating 628 transmitting the information directly to another device (e.g., the ultimate destination) via radio frequency signaling or some other type of signaling suitable for the applicable communication medium.

The circuit/module for communicating 628 (e.g., a means for communicating) may take various forms. In some aspects, the circuit/module for communicating 624 may correspond to, for example, an interface (e.g., a bus interface, a send/receive interface, or some other type of signal interface), a communication device, a transceiver, a transmitter, a receiver, or some other similar component as discussed herein. In some implementations, the communication interface 602 includes the circuit/module for communicating 628 and/or the code for communicating 638. In some implementations, the circuit/module for communicating 628 and/or the code for communicating 638 is configured to control the communication interface 602 (e.g., a transceiver, a receiver, or a transmitter) to communicate the information.

### First Example Process

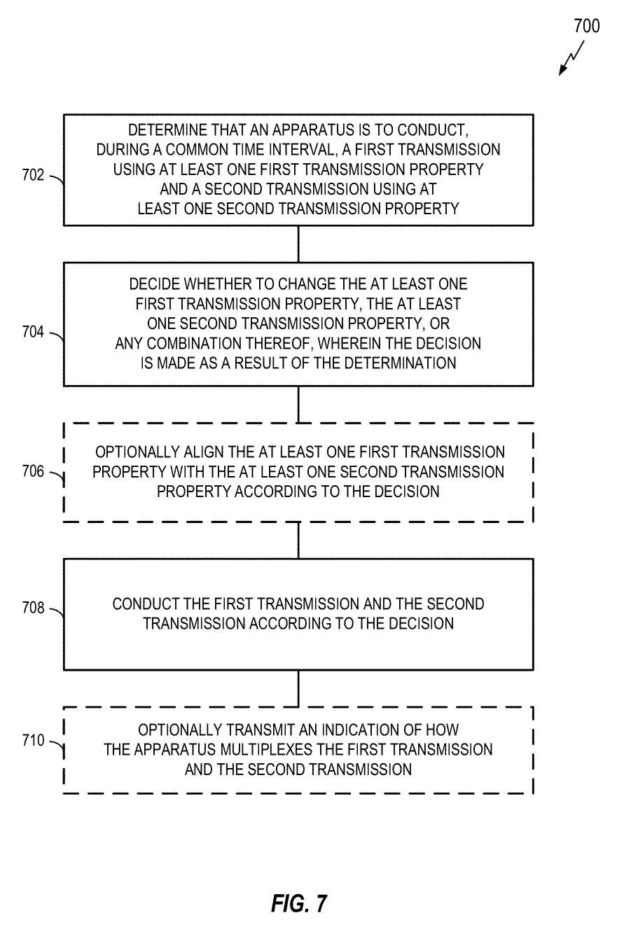

FIG. 7 illustrates a process 700 for communication in accordance with some aspects of the disclosure. The process 700 may take place within a processing circuit (e.g., the processing circuit 610 of FIG. 6), which may be located in a UE, an access terminal, a TRP, a base station, or some other suitable apparatus. Of course, in various aspects within the scope of the disclosure, the process 700 may be implemented by any suitable apparatus capable of supporting transmission-related operations.

At block 702, an apparatus (e.g., a UE) determines that the apparatus is to conduct, during a common time interval, a first transmission using at least one first transmission property and a second transmission using at least one second transmission property.

In some aspects, the at least one first transmission property and the at least one second transmission property may include at least one of: a tone spacing, a cyclic prefix (CP) duration, a waveform type, or any combination thereof. In some aspects, the waveform type may include at least one of: single-carrier frequency division multiple access (SC-FDMA); or orthogonal frequency-division multiplexing (OFDM).

The transmissions may take various forms. In some aspects, the second transmission may be a scheduled transmission; and the first transmission may be at least one of: an autonomous transmission with pre-configured transmission properties, a semi-persistent transmission, a contention-based transmission, a grant-free transmission, or any combination thereof. In some aspects, the first transmission may be associated with different reliability requirements than the second transmission. In some aspects, the first transmission may be for ultra-reliable low latency communication (URLLC); and the second transmission may be for enhanced mobile broadband (eMBB). In some aspects, the first transmission commences after the second transmission and the first and second transmissions complete at approximately the same time; the first transmission commences after the second transmission and completes prior to completion of the second transmission; or the first and second transmissions commence at approximately the same time and the first transmission completes prior to completion of the second transmission.

In some implementations, the circuit/module for determining 620 of FIG. 6 performs the operations of block 702. In some implementations, the code for determining 630 of FIG. 6 is executed to perform the operations of block 702.

At block 704, the apparatus decides whether to change the at least one first transmission property, the at least one second transmission property, or any combination thereof, wherein the decision may be made as a result of the determination. In some aspects, the at least one second transmission property may be changed only for the duration of the common time interval. In some aspects, the at least one second transmission property may be changed for the entirety of the second transmission.

The decision of block 704 may be based on various factors. In some aspects, the decision may be based on a first modulation and coding scheme (MCS) designated for the first transmission and a second MCS designated for the second transmission. In some aspects, the decision may be based on a first rank designated for the first transmission and a second rank designated for the second transmission. In some aspects, the decision may be based on a first resource block (RB) allocation for the first transmission and a second RB allocation for the second transmission. In some aspects, the decision may be based on resources usable for the first transmission and the second transmission. In some aspects, the decision may be based on first resource locations allocated for the first transmission and second resource locations allocated for the second transmission.

In some aspects, the decision may be based on a grant for the first transmission. In some aspects, the grant for the first transmission may override at least a portion of a grant for the second transmission.

In some aspects, the decision may be based on a grant for the second transmission. In some aspects, the grant for the second transmission may override at least a portion of a grant for the first transmission.

In some aspects, the at least one first transmission property may correspond to a first frequency-division multiplexing (FDM) numerology; the at least one second transmission property may correspond to a second frequency-division multiplexing (FDM) numerology; and the decision may include determining to align the first FDM numerology with the second FDM numerology.

In some aspects, the at least one first transmission property may correspond to a first quantity of transmission layers; the at least one second transmission property may correspond to a second quantity of transmission layers; and the decision may include determining to align the first quantity of transmission layers with the second quantity of transmission layers. In some aspects, the transmission layers may include multiple-input multiple-output (MIMO) layers.

In some implementations, the circuit/module for deciding 622 of FIG. 6 performs the operations of block 704. In some implementations, the code for deciding 632 of FIG. 6 is executed to perform the operations of block 704.

At optional block 706, the apparatus may align the at least one first transmission property with the at least one second transmission property according to the decision. In some aspects, the at least one second transmission property may include single-carrier frequency division multiple access (SC-FDMA); and the alignment may include using SC-FDMA to transmit the first transmission and the second transmission together. In some aspects, the at least one second transmission property may include orthogonal frequency-division multiplexing (OFDM); and the alignment may include using single-carrier frequency division multiple access (SC-FDMA) for the at least one first transmission property and the at least one second transmission property. In some aspects, the at least one second transmission property may include a particular tone spacing; and the alignment may include changing the at least one first transmission property to the particular tone spacing. In some aspects, the at least one second transmission property may include a particular cyclic prefix (CP) duration; and the alignment may include changing the at least one first transmission property to the particular CP duration.

In some implementations, the circuit/module for aligning 626 of FIG. 6 performs the operations of block 706. In some implementations, the code for aligning 636 of FIG. 6 is executed to perform the operations of block 706.

At block 708, the apparatus conducts (e.g., transmits) the first transmission and the second transmission according to the decision.

In some implementations, the circuit/module for conducting 624 of FIG. 6 performs the operations of block 708. In some implementations, the code for conducting 634 of FIG. 6 is executed to perform the operations of block 708.

At optional block 710, the apparatus may transmit an indication of how the apparatus multiplexes the first transmission and the second transmission. The indication may be transmitted in various ways. In some aspects, the indication may be indicated by a type of a demodulation reference signal (DMRS) transmitted by the apparatus. In some aspects, the transmission of the indication may include transmitting a message. In some aspects, the message may be a layer 1 signal embedded into one or both of the first transmission or the second transmission.

In some implementations, the circuit/module for communicating 628 of FIG. 6 performs the operations of block 710. In some implementations, the code for communicating 638 of FIG. 6 is executed to perform the operations of block 710.

In various implementations, a process may include any combination of the features described above for FIG. 6.

### Second Example Apparatus

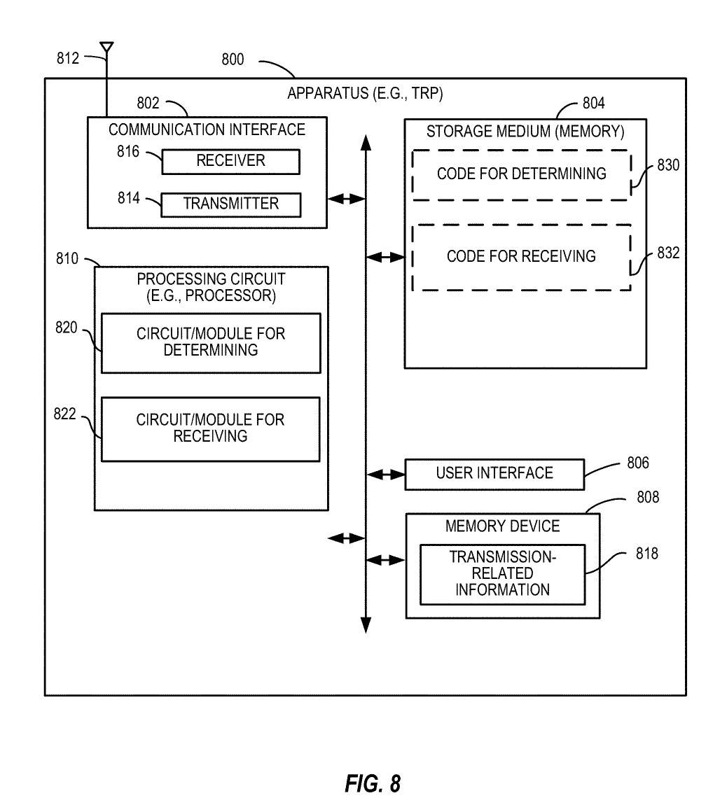

FIG. 8 illustrates a block diagram of an example hardware implementation of an apparatus 800 configured to communicate according to one or more aspects of the disclosure. The apparatus 800 could embody or be implemented within a TRP, an access point, a UE, or some other type of device that uses parallel transmissions as taught herein. In various implementations, the apparatus 800 could embody or be implemented within a base station, an access terminal, or some other type of device. In various implementations, the apparatus 800 could embody or be implemented within a server, a network entity, a mobile phone, a smart phone, a tablet, a portable computer, a server, a personal computer, a sensor, an entertainment device, a medical device, or any other electronic device having circuitry.

The apparatus 800 includes a communication interface 802 (e.g., at least one transceiver), a storage medium 804, a user interface 806, a memory device 808 (e.g., storing transmission-related information 818), and a processing circuit 810 (e.g., at least one processor). In various implementations, the user interface 806 may include one or more of: a keypad, a display, a speaker, a microphone, a touchscreen display, of some other circuitry for receiving an input from or sending an output to a user. The communication interface 802 may be coupled to one or more antennas 812, and may include a transmitter 814 and a receiver 816. In general, the components of FIG. 8 may be similar to corresponding components of the apparatus 600 of FIG. 6.

According to one or more aspects of the disclosure, the processing circuit 810 may be adapted to perform any or all of the features, processes, functions, operations and/or routines for any or all of the apparatuses described herein. For example, the processing circuit 810 may be configured to perform any of the steps, functions, and/or processes described with respect to FIGS. 1-5 and 9. As used herein, the term “adapted” in relation to the processing circuit 810 may refer to the processing circuit 810 being one or more of configured, used, implemented, and/or programmed to perform a particular process, function, operation and/or routine according to various features described herein.

The processing circuit 810 may be a specialized processor, such as an application specific integrated circuit (ASIC) that serves as a means for (e.g., structure for) carrying out any one of the operations described in conjunction with FIGS. 1-5 and 9. The processing circuit 810 may serve as one example of a means for transmitting and/or a means for receiving. In various implementations, the processing circuit 810 may provide and/or incorporate the functionality of the TRP 204 of FIG. 2.

According to at least one example of the apparatus 800, the processing circuit 810 may include one or more of a circuit/module for determining 820 or a circuit/module for receiving 822. In various implementations, the circuit/module for determining 820 or the circuit/module for receiving 822 may provide and/or incorporate, at least in part, the functionality described above for the TRP 204 of FIG. 2.

As mentioned above, programming stored by the storage medium 804, when executed by the processing circuit 810, causes the processing circuit 810 to perform one or more of the various functions and/or process operations described herein. For example, the programming, when executed by the processing circuit 810, may cause the processing circuit 810 to perform the various functions, steps, and/or processes described herein with respect to FIGS. 1-5 and 9 in various implementations. In some aspects, the storage medium 804 may include one or more of code for determining 830 or code for receiving 832. In various implementations, the code for determining 830 or the code for receiving 832 may be executed or otherwise used to provide the functionality described herein for the circuit/module for determining 820 or the circuit/module for receiving 822.

The circuit/module for determining 820 may include circuitry and/or programming (e.g., code for determining 830 stored on the storage medium 804) adapted to perform several functions relating to, for example, determining an indication of at least one transmission property. In some aspects, the circuit/module for determining 820 (e.g., a means for determining) may correspond to, for example, a processing circuit.

In some scenarios, the circuit/module for determining 820 may obtain the indication (e.g., from the communication interface 802, the memory device 808, or some other component of the apparatus 800). The circuit/module for determining 820 may then determine (e.g., based on schedule information) when the corresponding at least one transmission property is to be used for a transmission by another apparatus. The circuit/module for determining 820 may then output the indication (e.g., to the circuit/module for receiving 822, the memory device 808, or some other component).

The circuit/module for receiving 822 may include circuitry and/or programming (e.g., code for receiving 832 stored on the storage medium 804) adapted to perform several functions relating to, for example, receiving information. In some scenarios, the circuit/module for receiving 822 may obtain information (e.g., from the communication interface 802, the memory device, or some other component of the apparatus 800) and process (e.g., decode) the information. In some scenarios (e.g., if the circuit/module for receiving 822 is or includes an RF receiver), the circuit/module for receiving 822 may receive information directly from a device that transmitted the information. In either case, the circuit/module for receiving 822 may output the obtained information to another component of the apparatus 800 (e.g., the memory device 808 or some other component).

The circuit/module for receiving 822 (e.g., a means for receiving) may take various forms. In some aspects, the circuit/module for receiving 822 may correspond to, for example, an interface (e.g., a bus interface, a /receive interface, or some other type of signal interface), a communication device, a transceiver, a receiver, or some other similar component as discussed herein. In some implementations, the communication interface 802 includes the circuit/module for receiving 822 and/or the code for receiving 832. In some implementations, the circuit/module for receiving 822 and/or the code for receiving 832 is configured to control the communication interface 802 (e.g., a transceiver or a receiver) to receive information.

### Second Example Process

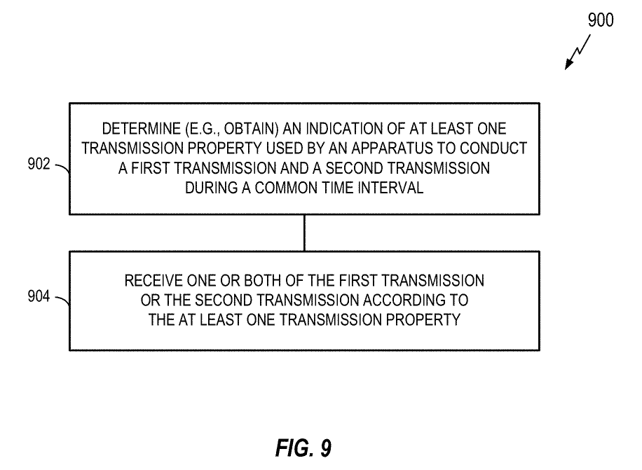

FIG. 9 illustrates a process 900 for communication in accordance with some aspects of the disclosure. The process 900 may take place within a processing circuit (e.g., the processing circuit 810 of FIG. 8), which may be located in a TRP, a base station, a UE, an access terminal, or some other suitable apparatus. Of course, in various aspects within the scope of the disclosure, the process 900 may be implemented by any suitable apparatus capable of supporting transmission-related operations.

At block 902, an apparatus (e.g., a TRP) determines (e.g., obtains) an indication of at least one transmission property used by an apparatus to conduct a first transmission and a second transmission during a common time interval. In some aspects, the at least one transmission property may be indicated by a type of a demodulation reference signal (DMRS) received from the apparatus. In some aspects, the determination (e.g., obtaining) of the indication may include receiving a message from the apparatus. In some aspects, the message may be a layer 1 signal embedded into one or both of the first transmission or the second transmission. In some aspects, the indication may indicate how the apparatus multiplexes the first transmission and the second transmission.

In some aspects, the at least one transmission property may include at least one of a tone spacing, a cyclic prefix (CP) duration, a waveform type, or any combination thereof. In some aspects, the waveform type may include at least one of: single-carrier frequency division multiple access (SC-FDMA) or orthogonal frequency-division multiplexing (OFDM). In some aspects, the at least one transmission property may correspond to a frequency-division multiplexing (FDM) numerology.

In some aspects, the at least one transmission property may correspond to a quantity of transmission layers. In some aspects, the transmission layers may include multiple-input multiple-output (MIMO) layers.

In some implementations, the circuit/module for determining 820 of FIG. 8 performs the operations of block 902. In some implementations, the code for determining 830 of FIG. 8 is executed to perform the operations of block 902.

At block 904, the apparatus receives one or both of the first transmission or the second transmission according to the at least one transmission property. In some aspects, the second transmission is a scheduled transmission and the first transmission is at least one of an autonomous transmission with pre-configured transmission properties, a semi-persistent transmission, a contention-based transmission, a grant-free transmission, or any combination thereof. In some aspects, the first transmission is associated with different reliability requirements than the second transmission. In some aspects, the first transmission is for ultra-reliable low latency communication (URLLC) and the second transmission is for enhanced mobile broadband (eMBB). In some aspects, the first transmission commences after the second transmission and the first and second transmissions complete at approximately the same time, the first transmission commences after the second transmission and completes prior to completion of the second transmission, or the first and second transmissions commence at approximately the same time and the first transmission completes prior to completion of the second transmission. In some aspects, the first transmission is associated with different latency requirements than the second transmission.

In some implementations, the circuit/module for receiving 822 of FIG. 8 performs the operations of block 904. In some implementations, the code for receiving 832 of FIG. 8 is executed to perform the operations of block 904.

In various implementations, a process may include any combination of the features described above for FIG. 8.

### Additional Aspects

Aspects of the present disclosure provide for a method, apparatus, and/or computer-readable medium for determining that an apparatus is to conduct, during a common time interval, a first transmission using at least one first transmission property and a second transmission using at least one second transmission property, deciding whether to change the at least one first transmission property, the at least one second transmission property, or any combination thereof, wherein the decision is made as a result of the determination, and conducting the first transmission and the second transmission according to the decision.

In an aspect of the disclosure, the at least one first transmission property and the at least one second transmission property include at least one of: a tone spacing, a cyclic prefix (CP) duration, a waveform type, or any combination thereof. The waveform type may be, for example, be single-carrier frequency division multiple access (SC-FDMA) or orthogonal frequency-division multiplexing (OFDM). In an aspect of the disclosure, the decision includes deciding not to change the at least one first transmission property and the at least one second transmission property.

Aspects of the present disclosure further provide the method, apparatus, and/or computer-readable medium for aligning the at least one first transmission property with the at least one second transmission property according to the decision. In an aspect of the disclosure, the at least one second transmission property includes single-carrier frequency division multiple access (SC-FDMA), and the alignment includes using SC-FDMA to transmit the first transmission and the second transmission together. In an aspect of the disclosure, the at least one second transmission property includes orthogonal frequency-division multiplexing (OFDM), and the alignment includes using single-carrier frequency division multiple access (SC-FDMA) for the at least one first transmission property and the at least one second transmission property. In an aspect of the disclosure, the at least one second transmission property includes a particular tone spacing, and the alignment includes changing the at least one first transmission property to the particular tone spacing. In an aspect of the disclosure, the at least one second transmission property includes a particular cyclic prefix (CP) duration, and the alignment includes changing the at least one first transmission property to the particular CP duration.

In an aspect of the disclosure, the at least one second transmission property is changed only for the duration of the common time interval, or the at least one second transmission property is changed for the entirety of the second transmission.

In an aspect of the disclosure, the decision is based on a grant for the first transmission or a grant for the second transmission. The grant for the first transmission may override at least a portion of the grant for the second transmission, or the grant for the second transmission may override at least a portion of the grant for the first transmission.

In an aspect of the disclosure, the decision is based on a first modulation and coding scheme (MCS) designated for the first transmission and a second MCS designated for the second transmission. In an aspect of the disclosure, the decision is based on a first rank designated for the first transmission and a second rank designated for the second transmission. In an aspect of the disclosure, the decision is based on a first resource block (RB) allocation for the first transmission and a second RB allocation for the second transmission. In an aspect of the disclosure, the decision is based on resources usable for the first transmission and the second transmission. In an aspect of the disclosure, the decision is based on first resource locations allocated for the first transmission and second resource locations allocated for the second transmission.

Aspects of the present disclosure further provide the method, apparatus, and/or computer-readable medium for transmitting an indication of how the apparatus multiplexes the first transmission and the second transmission. The indication may be indicated, for example, by a type of a demodulation reference signal (DMRS) transmitted by the apparatus. The transmission of the indication may include transmitting a message. The message may include, for example, a layer 1 signal embedded into one or both of the first transmission or the second transmission.

In an aspect of the disclosure, the second transmission is a scheduled transmission, and the first transmission is at least one of: an autonomous transmission with pre-configured transmission properties, a semi-persistent transmission, a contention-based transmission, a grant-free transmission, or any combination thereof.

In an aspect of the disclosure, the at least one first transmission property corresponds to a first frequency-division multiplexing (FDM) numerology, the at least one second transmission property corresponds to a second frequency-division multiplexing (FDM) numerology, and the decision includes determining to align the first FDM numerology with the second FDM numerology.

In an aspect of the disclosure, the at least one first transmission property corresponds to a first quantity of transmission layers, the at least one second transmission property corresponds to a second quantity of transmission layers, and the decision includes determining to align the first quantity of transmission layers with the second quantity of transmission layers. The transmission layers may include multiple-input multiple-output (MIMO) layers.

In an aspect of the disclosure, the first transmission is associated with different latency requirements than the second transmission. In an aspect of the disclosure, the first transmission is associated with different reliability requirements than the second transmission. In an aspect of the disclosure, the first transmission is for ultra-reliable low latency communication (URLLC), and the second transmission is for enhanced mobile broadband (eMBB).

In an aspect of the disclosure, the first transmission commences after the second transmission and the first and second transmissions complete at approximately the same time, the first transmission commences after the second transmission and completes prior to completion of the second transmission, or the first and second transmissions commence at approximately the same time and the first transmission completes prior to completion of the second transmission.

Other aspects of the present disclosure provide for a method, apparatus, and/or computer-readable medium for obtaining an indication of at least one transmission property used by an apparatus to conduct a first transmission and a second transmission during a common time interval and receiving one or both of the first transmission or the second transmission according to the at least one transmission property. In an aspect of the disclosure, the at least one transmission property is indicated by a type of a demodulation reference signal (DMRS) received from the apparatus. In an aspect of the disclosure, the obtaining of the indication includes receiving a message from the apparatus. In an aspect of the disclosure, the message includes a layer 1 signal embedded into one or both of the first transmission or the second transmission. In an aspect of the disclosure, the indication indicates how the apparatus multiplexes the first transmission and the second transmission. In an aspect of the disclosure, the at least one transmission property includes at least one of: a tone spacing, a cyclic prefix (CP) duration, a waveform type, or any combination thereof. The waveform type includes, for example, at least one of single-carrier frequency division multiple access (SC-FDMA), or orthogonal frequency-division multiplexing (OFDM). In an aspect of the disclosure, the second transmission is a scheduled transmission, and the first transmission is at least one of: an autonomous transmission with pre-configured transmission properties, a semi-persistent transmission, a contention-based transmission, a grant-free transmission, or any combination thereof. In an aspect of the disclosure, the at least one transmission property corresponds to a frequency-division multiplexing (FDM) numerology. In an aspect of the disclosure, the at least one transmission property corresponds to a quantity of transmission layers. The transmission layers include, for example, multiple-input multiple-output (MIMO) layers. In an aspect of the disclosure, the first transmission is associated with different latency requirements than the second transmission. In an aspect of the disclosure, the first transmission is associated with different reliability requirements than the second transmission. In an aspect of the disclosure, the first transmission is for ultra-reliable low latency communication (URLLC), and the second transmission is for enhanced mobile broadband (eMBB). In an aspect of the disclosure, the first transmission commences after the second transmission and the first and second transmissions complete at approximately the same time, the first transmission commences after the second transmission and completes prior to completion of the second transmission, or the first and second transmissions commence at approximately the same time and the first transmission completes prior to completion of the second transmission.

### Other Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As those skilled in the art will readily appreciate, various aspects described throughout this disclosure may be extended to any suitable telecommunication system, network architecture, and communication standard. By way of example, various aspects may be applied to wide area networks, peer-to-peer network, local area network, other suitable systems, or any combination thereof, including those described by yet-to-be defined standards.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application-specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example of a storage medium is coupled to the processor such that the processor can read information from, and write information to, the storage medium. In the alternative, the storage medium may be integral to the processor.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may comprise one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

What is claimed is:

1. A method of communication, comprising:
determining that an apparatus is to conduct, during a common time interval, a first transmission using at least one first transmission property and a second transmission using at least one second transmission property;
deciding whether to change the at least one first transmission property, the at least one second transmission property, or any combination thereof, wherein the decision is made as a result of the determination; and
conducting the first transmission and the second transmission according to the decision.

2. The method of claim 1, wherein the at least one first transmission property and the at least one second transmission property comprise at least one of: a tone spacing, a cyclic prefix (CP) duration, or any combination thereof.

3. The method of claim 1, further comprising aligning the at least one first transmission property with the at least one second transmission property according to the decision.

4. The method of claim 3, wherein:
the at least one second transmission property comprises single-carrier frequency division multiple access (SC-FDMA); and
the alignment comprises using SC-FDMA to transmit the first transmission and the second transmission together.

5. The method of claim 3, wherein:
the at least one second transmission property comprises orthogonal frequency-division multiplexing (OFDM); and
the alignment comprises using single-carrier frequency division multiple access (SC-FDMA) for the at least one first transmission property and the at least one second transmission property.

6. The method of claim 3, wherein:
the at least one second transmission property comprises a particular tone spacing and the alignment comprises changing the at least one first transmission property to the particular tone spacing; or
the at least one second transmission property comprises a particular cyclic prefix (CP) duration and the alignment comprises changing the at least one first transmission property to the particular CP duration.

7. The method of claim 1, wherein:
the at least one second transmission property is changed only for a duration of the common time interval; or
the at least one second transmission property is changed for an entirety of the second transmission.

8. The method of claim 1, wherein the decision is based on a grant for the first transmission or a grant for the second transmission.

9. The method of claim 8, wherein the grant for the first transmission overrides at least a portion of the grant for the second transmission or the grant for the second transmission overrides at least a portion of the grant for the second transmission.

10. The method of claim 1, wherein the decision is based on a first resource block (RB) allocation for the first transmission and a second RB allocation for the second transmission.

11. The method of claim 1, wherein the decision is based on first resource locations allocated for the first transmission and second resource locations allocated for the second transmission.

12. The method of claim 1, wherein:
the second transmission is a scheduled transmission; and
the first transmission is at least one of: an autonomous transmission with pre-configured transmission properties, a semi-persistent transmission, a contention-based transmission, a grant-free transmission, or any combination thereof.

13. The method of claim 1, wherein:
the at least one first transmission property corresponds to a first frequency-division multiplexing (FDM) numerology;
the at least one second transmission property corresponds to a second frequency-division multiplexing (FDM) numerology; and
the decision comprises determining to align the first FDM numerology with the second FDM numerology.

14. The method of claim 1, wherein the first transmission is associated with at least one of: different latency requirements than the second transmission, different reliability requirements than the second transmission, or any combination thereof.

15. The method of claim 1, wherein:
the first transmission is for ultra-reliable low latency communication (URLLC); and
the second transmission is for enhanced mobile broadband (eMBB).

16. The method of claim 1, wherein:
the first transmission commences after the second transmission and the first and second transmissions complete at approximately the same time;
the first transmission commences after the second transmission and completes prior to completion of the second transmission; or
the first and second transmissions commence at approximately the same time and the first transmission completes prior to completion of the second transmission.

17. An apparatus for communication comprising:
a memory; and
a processor coupled to the memory,
the processor and the memory configured to:
determine that the apparatus is to conduct, during a common time interval, a first transmission using at least one first transmission property and a second transmission using at least one second transmission property;
decide whether to change the at least one first transmission property, the at least one second transmission property, or any combination thereof, wherein the decision is made as a result of the determination; and
conduct the first transmission and the second transmission according to the decision.

18. A method of communication, comprising:
determining an indication of at least one transmission property used by an apparatus to conduct a first transmission and a second transmission during a common time interval; and
receiving one or both of the first transmission or the second transmission according to the at least one transmission property.

19. The method of claim 18, wherein the at least one transmission property is indicated by a type of a demodulation reference signal (DMRS) received from the apparatus.

20. The method of claim 18, wherein:
the second transmission is a scheduled transmission; and
the first transmission is at least one of: an autonomous transmission with pre-configured transmission properties, a semi-persistent transmission, a contention-based transmission, a grant-free transmission, or any combination thereof.
